(19) United States
(12) Patent Application Publication
(10) Pub. No.: US 2012/0316911 A1
(43) Pub. Date: Dec. 13, 2012

(54) SMART SCHEDULING SYSTEM

(76) Inventor: Jacob Patrick Schwarz, Nashville, TN (US)

(21) Appl. No.: 13/492,429

(22) Filed: Jun. 8, 2012

Related U.S. Application Data
(60) Provisional application No. 61/495,301, filed on Jun. 9, 2011.

(51) Int. Cl. G06Q 10/10

(52) U.S. Cl. 705/7.19

(57) ABSTRACT

In embodiments of the present invention, improved capabilities are described for, gathering, storing, managing, aggregating, searching and processing scheduling data to produce prioritized event scheduling for appointments, reservations, procedures or other interactions based at least in part on the manual or algorithmic application of scheduling rules.

### CROSS-REFERENCE TO RELATED APPLICATIONS

This application claims the benefit of the following provisional application, which is hereby incorporated by reference herein in its entirety: U.S. Provisional Patent Application Ser. No. 61/495,301 filed Jun. 9, 2011.

### BACKGROUND

1. Field

The invention is related to the field of scheduling, and methods and systems for the creation of a prioritized event schedule.

2. Description of the Related Art

Setting appointments has become more convenient with the advent of calendar software programs. However, while people continue to try to make scheduling appointments between parties easier it continues to require significant effort. A need exists to improve how parties schedule appointments.

### SUMMARY

Traditional event scheduling, such as scheduling an appointment to see a physician or reserving a table at a restaurant, has primarily focused on evaluating open timeslots in a schedule and placing each schedule request in a timeslot until the schedule is “booked,” or filled with appointments. Considerations of the differing values placed on the timeslots by the entity with whom an appointment is to be scheduled are not taken into account when placing an appointment, nor is information relating to the party seeking to make an appointment. The traditional scheduling systems therefore do not utilize additional sources of information regarding what is valued by the scheduling entity and what is known about the parties scheduling appointments in order to maximize the effectiveness of a scheduling process to align higher priority scheduling parties and higher priority scheduling timeslots. Therefore a need exists for a scheduling system that may account for information that is know about a party seeking to schedule an event and metadata, such as scheduling rules, relating to the entity with whom the event is to be scheduled.

In embodiments of the present invention, a method for prioritizing event scheduling with a Smart Scheduling System is provided. A datum may be received from an entity with whom an event may be scheduled, wherein the datum provides a scheduling preference of the entity. The datum may be stored as a scheduling prioritization metadata within a prioritization database. A request to schedule an event with the entity may be received from a user, and data within the prioritization database, and at least one user characteristic datum relating to the user, may be analyzed to form a user ranking. The ranking may be used in order to select a set of scheduling opportunities to make available for the user to schedule an event, and the set of scheduling opportunities may be presented to the user. As a last step, an event may be scheduled for the user with the entity in a schedule timeslot based at least in part on a selection made by the user from among the set of scheduling opportunities, wherein the user may be preferentially placed within the timeslot even if the timeslot were previously occupied by a second user so long as the user's ranking is higher than the second user's ranking.

In embodiments, the entity may be a business entity or an individual. A business entity may include, but is not limited to, a hospital, physician's office, gymnasium, restaurant, retail business, or some other type of business entity. An individual may include a physician, a business owner, a restaurateur, or some other type of individual.

In embodiments, a datum or data used by the Smart Scheduling System may include, but is not limited to, data relating to a physician group, a referral source (such as a patient referral source, a reimbursement source, such as an insurer, financial data, historical data regarding prior scheduling, or some other type of data that may be used by the Smart Scheduling System. In embodiments, a user characteristic may relate to a prior interaction with the entity.

In embodiments, a preferential placement within a scheduling timeslot may result in double-booking the timeslot so that a second user and a first user of the Smart Scheduling System are both are scheduled within the timeslot.

In embodiments of the present invention, a method is provided for creating event scheduling priority metadata within a Smart Scheduling System. For example, a physician learning model may be used that is associated with an event scheduling system, and equipped with a user interface, to receive a scheduling preference datum from a physician that at least in part expresses a scheduling preference of the physician. The scheduling preference datum may be stored as a priority metadatum that is associated with the event scheduling system. An event datum may be received by the scheduling system that is related to an event result that is associated with a patient's prior scheduled event. The event datum may be analyzed in conjunction with the scheduling preference datum, and a priority rule associated with the patient may be created that is based at least in part on the analysis result, wherein the priority rule quantitatively models the priority to be given to the patient, and which may be used by the event scheduling system to place the patient within the physician's calendar when the patient attempts to schedule a second event at a time subsequent to the event result.

In embodiments, an event datum may be based at least in part on the occurrence of a defect during the event, such as a missed appointment, failure to pay for service, a late arrival, or some other defect that occurred during the event.

In embodiments of the present invention, a method is provided for placing advertising within an event scheduling system. In an embodiment, an advertisement may be selected for presentation to a user of an event scheduling system, wherein the selection is based at least in part on a relevance to a scheduling rule that is associated with a scheduled appointment viewed by the user within the event scheduling system. The advertisement may be presented to the user within a user interface associated with the event scheduling system. In embodiments, the scheduling rule may be based at least in part on at least one event datum relating to an event that occurred during a prior appointment that is recorded within the event scheduling system, and may be further based on a scheduling rule and an economic rule that are stored in a rules engine that is associated with the event scheduling system.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

FIG. 1 illustrates a scheduling platform that may be used to create event schedules based at least in part on the use of a prioritization engine and the analysis of metadata relating to the users of the scheduling system.

FIG. 2 illustrates a simplified embodiment of prioritizing the event schedules of multiple users using the Smart Scheduling System of the present invention.

FIG. 3 illustrates an example usage of a physician learning module and the development of scheduling priority metadata.

FIG. 4 illustrates a simplified embodiment of associating an advertisement for presentation to a user based on event data.

FIG. 5 illustrates an embodiment of the Smart Scheduling System applied to the scheduling of appointments at a gym.

FIG. 6 illustrates an embodiment of the Smart Scheduling System applied to the reservation of a table at a restaurant.

FIG. 7 illustrates an example presentation of a schedule and the availability within the schedule as it may be presented to two different people wanting to schedule an appointment with the same entity or person based on the principles of the present invention.

### DETAILED DESCRIPTION

The inventor has appreciated that scheduling of appointments can be made easier and more effective by understanding the needs of the parties attempting to set the appointment. Busy people have busy schedules and the open slots in their schedule become an important commodity that needs to be managed well. As will be explained in greater detail herein, a doctor, for example, may have a very busy schedule but she may still need to book certain people with a higher urgency than other people. A follow-up from surgery may carry a higher urgency than a newly referred person. The doctor may also have times in her schedule that appear open but have an increased likelihood of becoming consumed by even higher priority matters. For example, the doctor may have two appointments to consider: the newly referred patient and a follow-up for an existing patient that just underwent a procedure. The doctor may also have two open slots in her schedule: slot A and slot B. Slot A is at a time when emergency surgeries tend to take place, for example, early in the morning. Slot B may be considered a more reliable slot because it is at a time when there are few outside factors affecting the schedule. A Smart Scheduling System according to the principles of the present invention would understand the reliability of the two scheduling slots and the needs of the two different people trying to schedule an appointment and it would set the appointments according. For example, the system may schedule the existing patient requiring the follow-up appointment in slot B to increase the chances that the patient is seen per the plan.

As will be seen below, a Smart Scheduling System in accordance to the principles of the present invention may relate to many types of appointments and parties. The system may be a system that helps a person in setting appointments or the system may be a more automated system that allows the scheduling of appointments based on the known information, requirements and restrictions.

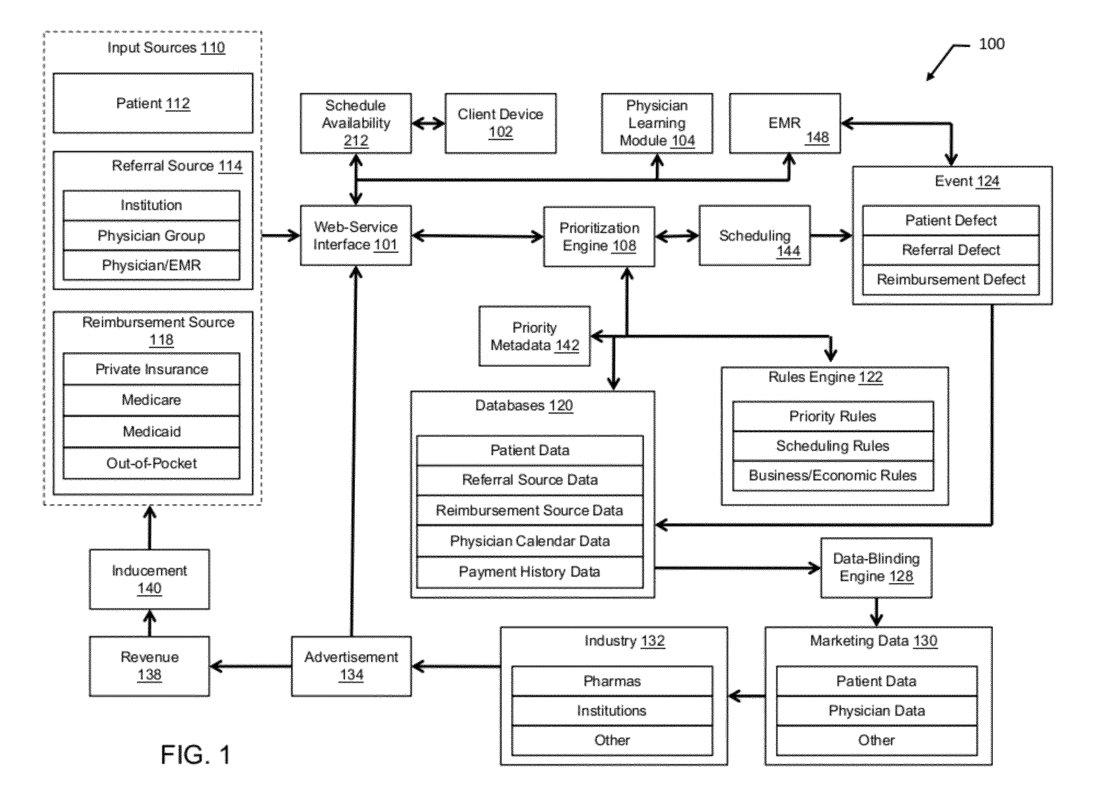

As shown in FIG. 1, in embodiments of the present invention, a Smart Scheduling System (SSS) 100 is provided that is enabled to gather, store, manage, aggregate, search and process scheduling data to produce prioritized event scheduling for appointments, reservations, procedures or other interactions based at least in part on the manual or algorithmic application of scheduling rules. In embodiments, the SSS 100 may be a web service that may be accessible through a web service interface 101 and/or hard-wired service with which a plurality of client devices 102 may be associated. Client devices 102 may include, but are not limited to, a mainframe computer, server, desktop computer, laptop computer, e-notebook, e-book, e-tablet, PDA, cellular phone, or some other digital device. The scheduling service 100 may have a user interface that is enabled to receive data inputs from human users and/or from automated or machine data sources. The client devices 102 may be physically linked to the web service, such as within a physician's office intranet, or may link to the web service remotely over a wireless or other type of remote connection, including but not limited to the Internet or cellular telecommunications system. The client device 102 may enable a user, such as a patient, medical office administrator or some other user type, to log in to an account to input data to schedule an event (e.g., an appointment with a physician, or some other event type) including, but not limited to, a preferred day and time, whether the patient is new or recurrent, and for what purpose the patient is scheduling the appointment. The SSS 100 service may be further associated with a physician learning module 104. The physician learning module 104 may enable physicians or other medical professionals to input criteria and preferences for scheduling appointments including, but not limited to, specific days and/or times a physician is available to schedule appointments, the types of insurance a physician accepts, or whether a physician will accept referrals, and the like. The physician learning module 104 may also enable physicians to prioritize types of data. These prioritized data may be utilized by the SSS 100 as priority metadata 142 that informs the prioritization engine 108 how to handle a given scheduling request that is received by the SSS 100 service. In an example, a medical specialist, such as a cardiologist, may select a number of general physicians s/he accepts referrals from and designate the type of availability (e.g. always available, generally available, rarely available) s/he has for each referral source, select the types of insurance s/he accepts and designate priorities, select the types of diagnoses s/he treats and designate priorities or prioritize appointments, or provide some other type of data to the SSS 100 service. In another example, a primary care physician may create a list of specialists s/he has referred patients to and prioritize those specialists for future referrals, select the types of insurance s/he accepts and designate priorities, select the types of diagnoses s/he treats and designate priorities or prioritize appointments, or provide some other type of data to the SSS 100 service. Data for scheduling 144 may also be derived from an electronic medical record 148.

Still referring to FIG. 1, the SSS 100 may facilitate the retrieval of data input sources 110 including, but not limited to, data from or relating to patients 112, referral sources 114 and/or reimbursement sources 118. Referral sources may include, but are not limited to, institutional data (e.g., hospital data), physician group data (e.g., data from or relating to a cardiology practice group), and/or data from or relating to an individual physician. Reimbursement sources may include, but are not limited to, data from or relating to private insurers, government insurers, such as Medicare or Medicaid data, or out-of-pocket reimbursements. The SSS 100 may include a prioritization engine 108 that may utilize the data from the input sources 110 to make informed scheduling decisions for scheduling an event that is requested to be scheduled buy a user of the scheduling service 100. The prioritization engine 108 may process and review data 120 including, but not limited to, patient data, referral source data, reimbursement source data, physician calendar data, payment history data, priority metadata 142, data from a rules engine 122, or some other type of data. The rules engine 122 may include, but is not limited to, priority rules, scheduling rules or business/economic rules set by, for example, a physician. Priority rules may include, but are not limited to, rules governing preferences, such as a preference to schedule an appointment that is referred by Physician 1 over that referred by Physician 2. Scheduling rules may include, but are not limited to, physician preferences, for example scheduling a certain procedure type only on a given day of the week, and the like. Business/economic rules may relate to providing a higher priority to scheduling events that have a higher profit margin, and so on. Based at least in part on this data, the prioritization engine 108 may then schedule an event 124, such as an appointment meeting a patient's criteria that is scheduled in accordance with the priorities set by the physician or other personnel. The occurrence of an event 124 may yield additional data that may be used by the SSS 100. For example, a patient may not show up for an appointment with a physician, may not show up on time, a physician may not be reimbursed by an insurance company, or may be reimbursed without complications, a specialist may have an unpleasant experience with a referral source, and so forth. Such event data may be stored in databases that are associated with the SSS 100 service, as described herein, and further used by the prioritization engine 108 when scheduling subsequent events 124. This data may be further used to alter or add to the rules engines 122 that may be used by the prioritization engine 108. For example, if following five scheduled patient appointments, all of which were referred by Physician 3, each event results in the patient missing an appointment, the SSS 100 may update the rules engine 122 to include a rule that alters the priority given to Physician 3's requests to schedule an appointment.

Still referring to FIG. 1, in embodiments, the SSS 100 may include a data-blinding engine 128. The data-blinding engine 128 may transform stored data that is associated with the web-service into anonymous information that may be used as marketing data 130, such as that relating to patients, physicians, institutions, and the like. The marketing data 130 may be sold to industry 132 including, but not limited to, pharmaceutical companies, businesses targeting health care employees, or some other type of entity or institution, and used to generate revenue. For example, the marketing data 130 may have value to industry 132 for the purposes of targeting advertising 134 to specific patient populations (e.g., cardiology patients), physician group practices (e.g., physicians performing a particular procedure), or some other entity or institution (e.g., a hospital with a growing obese patient population base). The revenue 138 generated from the advertising may be used, in part, to induce 140 individuals and entities to use the SSS.

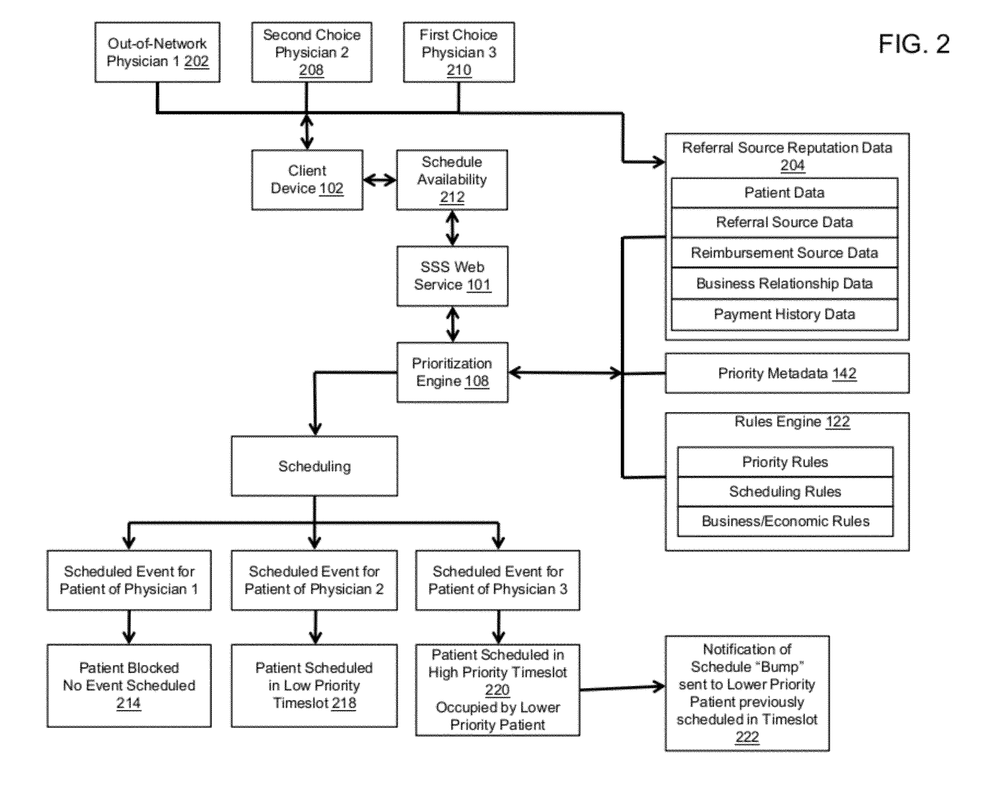

FIG. 2 depicts a simplified embodiment of referral source reputation and its utilization within the SSS 100 service for prioritizing an event schedule. In this example, three physicians would like to schedule an appointment with another physician, such as a specialist, or an institution, such as a hospital imaging facility. Physician 1 202 has had prior interaction with the entity with whom she is trying to make an appointment. This prior interaction has resulted in data relating to the prior events to be stored as referral source reputation data 204 that is associated with the SSS 100 service. In the case of Physician 1 202, the prior interactions resulted in identifying Physician 1 202 as an out-of-network physician. In the case of Physician 2 208, there is no prior interaction with the entity with whom he is trying to make an appointment. Thus, there may not be any referral source reputation data available that the prioritization engine 108 of the SSS 100 service may utilize in making scheduling priorities. In the case of Physician 3 210, the prior interactions resulted in at least one positive interaction that has caused the SSS 100 to categorize Physician 3 210 as a first choice for the purposes of scheduling. In another embodiment, the referral source reputation data 204 may be neutral, in that there may be at least one prior event relating to the user, such as a physician, but the event may not have resulted in a positive or negative interaction that was recorded by the system. In this case, the SSS 100 may categorize the physician with the neutral referral source reputation data as having a middle priority, meaning that this physician may be given a higher ranking than users that have some element of negative referral source reputation data, and a lower ranking that that users that have some element of positive referral source reputation data.

Continuing the example depicted in FIG. 2, each of the three physicians attempting to schedule an event may use a client device, as described herein, to access a physician's or entity's schedule availability 212 by accessing the SSS 100 service. Upon receiving the requests to schedule an event, the prioritization engine 108 that is associated with the SSS 100 service may utilize data such as referral source reputation data 204, priority metadata 142, and/or rules engine data. Referral source reputation data 204 may include, but is not limited to, patient data, referral source data, reimbursement source data, business relationship data, payment history data, or some other type of referral source data. The rules engine 122 may include priority rules, scheduling rules, business or economic rules, or some other type of rule. The prioritization engine 108 may access the data and rules in these repositories to create a prioritized event schedule in which the placement of events conform to the rules and priorities specified within the SSS 100, such as specifications and expressed priorities from physicians, institutions, or others utilizing the SSS 100 service. Continuing the example, because of the out-of network status of Physician 1 202, the scheduled event result for the patient of the Physician 1 that is made by the prioritization engine may be to block the patient and schedule to no event 214, the patient being blocked from scheduling due to this referral source/history. The patient of the unknown Physician 2 208 who has not previously interacted with the physician or entity with whom the schedule request is made may be scheduled within a second choice timeslot. This may permit the patient to begin an interaction history in a low priority timeslot 218, while preserving higher priority timeslots for patients referred from known and/or higher priority referral sources. In the case of the patient referred from the Physician 3 210, because of the positive event data associated with the Physician 3's prior interactions that are stored, at least in part, within the referral source reputation data, the scheduled event result for the patient of the Physician 3 210 that is made by the prioritization engine may be to schedule the patient in a first choice or higher priority timeslot 220. In the event that the higher priority timeslot is previously occupied by a second choice patient, the second choice patient occupying the timeslot requested by Physician 3 210 may be “bumped” from the timeslot and rescheduled to a different timeslot. As a result, the SSS 100 service may distribute a notification 222 to the patient and/or parties affiliated with the patient, such as a referring physician or physician's office, notifying the patient of the schedule change.

In embodiments, the Smart Scheduling System may enable the collection of payments due from patients (e.g., “copays”) at the time of service or in connection with their appointment. Determining the copay amount may be facilitated by accessing data or metadata associated with the patient scheduling the appointment and/or the reimbursement source from whom a physician expects payment for the patient's office consultation or other visit type. As part of collecting and processing the copays, the Smart Scheduling System may charge a commission, such as a percentage of the copy, to the physician, reimbursement source, or some other entity associated with the copay. In another example, the Smart Scheduling system may require that a fee be paid, such as a holding fee, by the party that is attempting to schedule an appointment in a given timeslot. The holding fee may be scaled according to a criterion, including but not limited to, priority metadata, priority rules, scheduling rules and the like. For example, a holding fee to reserve a calendar timeslot that a physician has indicated is a high value or high priority timeslot may be larger than the holding fee required to reserve a lower priority timeslot in the physician's calendar. The holding fee may function as a type of deposit to hold the appointment time slot.

In embodiments, the Smart Scheduling System, as described herein, may provide a method for prioritizing event scheduling. A datum may be received from an entity with whom an event may be scheduled, wherein the datum provides a scheduling preference of the entity. The datum may be stored as a scheduling prioritization metadata within a prioritization database. A request to schedule an event with the entity may be received from a user, and data within the prioritization database, and at least one user characteristic datum relating to the user, may be analyzed to form a user ranking. The ranking may be used in order to select a set of scheduling opportunities to make available for the user to schedule an event, and the set of scheduling opportunities may be presented to the user. As a last step, an event may be scheduled for the user with the entity in a schedule timeslot based at least in part on a selection made by the user from among the set of scheduling opportunities, wherein the user may be preferentially placed within the timeslot even if the timeslot were previously occupied by a second user so long as the user's ranking is higher than the second user's ranking.

In embodiments, the entity may be a business entity or an individual. A business entity may include, but is not limited to, a hospital, physician's office, gymnasium, restaurant, retail business, or some other type of business entity. An individual may include a physician, a business owner, a restaurateur, or some other type of individual.

In embodiments, a datum or data used by the Smart Scheduling System may include, but is not limited to, data relating to a physician group, a referral source (such as a patient referral source, a reimbursement source, such as an insurer, financial data, historical data regarding prior scheduling, or some other type of data that may be used by the Smart Scheduling System. In embodiments, a user characteristic may relate to a prior interaction with the entity.

In embodiments, a preferential placement within a scheduling timeslot may result in double-booking the timeslot so that a second user and a first user of the Smart Scheduling System are both are scheduled within the timeslot.

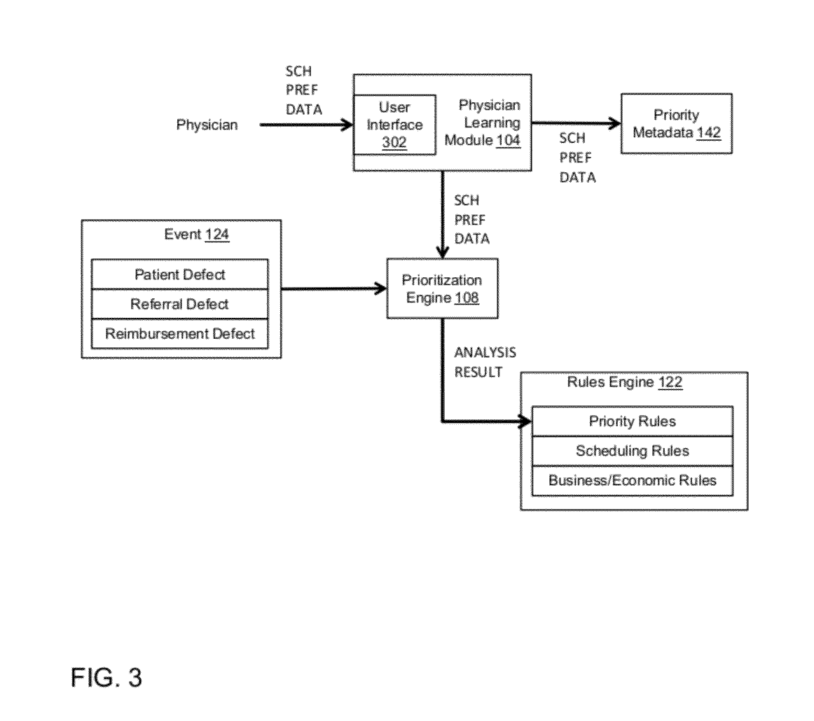

Referring to FIG. 3, in embodiments, the Smart Scheduling System, as described herein, may provide a method for creating event scheduling priority metadata 142. For example, a physician learning model 104 may be used that is associated with an event scheduling system, and equipped with a user interface 302, to receive a scheduling preference datum from a physician that at least in part expresses a scheduling preference of the physician. The scheduling preference datum may be stored as a priority metadatum 142 that is associated with the event scheduling system. An event datum 124 may be received by the scheduling system that is relating to an event result that is associated with a patient's prior scheduled event. The event datum may be analyzed by a prioritization engine 108 in conjunction with the scheduling preference datum, and a priority rule, such as that stored in a rules engine 122, that is associated with the patient may be created that is based at least in part on the analysis result, wherein the priority rule quantitatively models the priority to be given to the patient, and which may be used by the event scheduling system to place the patient within the physician's calendar when the patient attempts to schedule a second event at a time subsequent to the event result.

In embodiments, an event datum may be based at least in part on the occurrence of a defect during the event, such as a missed appointment, failure to pay for service, a late arrival, or some other defect that occurred during the event.

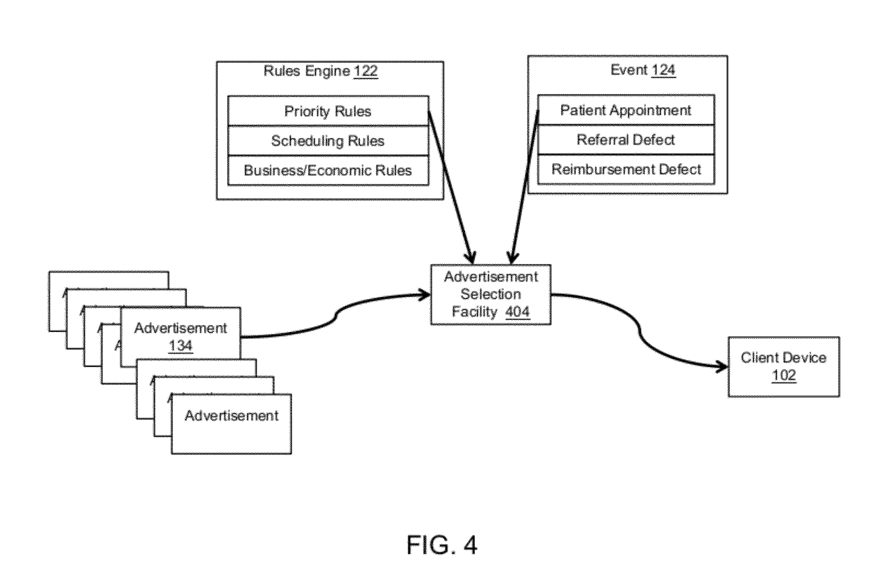

Referring to FIG. 4, in embodiments, the Smart Scheduling System, as described herein, may provide a method for placing advertising 134 within an event scheduling system. In an embodiment, an advertisement 134 may be selected for presentation to a client device 102 of a user of an event scheduling system, wherein the selection is based at least in part on a relevance to a scheduling rule, such as that stored in a rules engine 122, that is associated with a scheduled appointment viewed by the user within the event scheduling system. An advertisement selection facility 404 may select an advertisement 134 that may be presented to the user within a user interface associated with the event scheduling system. In embodiments, the scheduling rule may be based at least in part on at least one event datum 124 relating to an event that occurred during a prior appointment that is recorded within the event scheduling system, and may be further based on a scheduling rule and an economic rule that are stored in a rules engine 122 that is associated with the event scheduling system.

In an example embodiment, using a client device that is associated with the SSS service and prioritization engine, a patient may request to schedule an appointment with a primary care physician. The primary care physician may have previously indicated scheduling preference criteria based at least in part on data entered using the physician learning module. This data may include, but is not limited to, days and times s/he is available to schedule appointments, the types of insurance s/he is willing to accept, or some other type of scheduling preference data. The primary care physician may also indicate priorities for certain criteria including, but not limited to, first choice/second choice referral sources. Continuing with the example, the patient may be a regular patient or a new patient of the primary care physician. If the patient is a regular patient s/he may have a history of showing up late to a scheduled appointment or of not showing up at all without giving notice. The patient may have a history of not paying his/her deductible or copayment on time, making it difficult to process his/her insurance. Based on this patient's information history and the primary care physician's indicated criteria, the SSS service and prioritization engine may generate appointment options for the patient to choose from that conform to the scheduling preferences previously entered by the primary care physician. Due to this patient's unfavorable history with the primary care physician, s/he may be bumped or rescheduled if a more favorable patient makes an appointment. In another embodiment, the prioritization engine may force the scheduling of a favorable, or highly ranked patient or other user without bumping a currently scheduled patient. For example, the SSS may double-book a given timeslot to accommodate the new, highly ranked patient. The SSS might alter the timeslot duration of the existing scheduled patient (e.g., dropping the duration to a half-hour appointment from an hour-long appointment) in order to accommodate the placement of the new, highly ranked patient within the schedule. In another embodiment, the SSS may include a business rule that permits “double-booking,” meaning that it is permissible to schedule multiple parties to a single timeslot without removing an existing occupant of the timeslot.

In an example embodiment, using the physician learning module associated with the SSS service and prioritization engine, a primary care physician may refer a patient to a specialist. The primary care physician may indicate criteria including, but not limited to the area of specialty or specialties, the distance from the primary care physician's present location, the ideal time and date or the next available appointment, the reason for the referral and the primary care physician may limit his/her results to his/her favorite specialists. The primary care physician's criteria may be processed with data provided by specialists using the SSS service. A specialist may provide data including, but not limited to, days and times s/he is available to schedule appointments, the types of insurance s/he is willing to accept, or some other type of scheduling data or preference. A specialist may also indicate priorities for certain criteria including, but not limited to, designating the type of availability (e.g. always available, generally available, rarely available) s/he has for each referral source, selecting the types of diagnoses s/he treats and designating priorities for prioritizing appointments. Continuing with the example, the patient may need an appointment with a cardiologist, may be referred to a specialist with whom the primary care physician has a favorable referral history, and request a Wednesday afternoon appointment for a procedure, a favorable day and time for the specialist. Based on the primary care physician and specialist's inputted data, the SSS service and prioritization engine may generate an ideal appointment option for the primary care physician to choose from and to make available to the patient.

In another example embodiment, the SSS may enable the use of business rules or other data that allow multiple parties with whom events may be scheduled (e.g., physicians within a practice group) to coordinate their schedules and interact within the prioritization engine processes. For example, a patient may attempt to schedule an appointment with a first physician that is unavailable, but rather that the SSS rejecting the patient's scheduling request, the prioritization engine may utilize a business rule or some other data that is associated with the prioritization engine and determine that, while the first physician in the practice group is unavailable, a second physician, such as a colleague of the first physician with similar credentials and permissions, is available, and based at least in part on this the SSS may present the patient an opportunity to schedule an appointment with the second physician instead. In another example embodiment, the SSS may enable the use of business rules or other data that allow multiple parties with whom events may be scheduled where the parties have differing credentials (e.g., a primary care physician and a specialist) to coordinate their schedules and interact within the prioritization engine processes. For example, a patient may attempt to schedule an appointment with a specialist that is unavailable, but rather that the SSS rejecting the patient's scheduling request, the prioritization engine may utilize a business rule or some other data that is associated with the prioritization engine and determine that, while the specialist is unavailable, a second physician, such as the patient's primary care physician, is available, and based at least in part on this the SSS may present the patient an opportunity to schedule an appointment with the primary care physician instead.

In embodiments, the SSS may enable referring physicians, including a plurality of physicians with a relationship with a patient for whom an attempt to schedule an appointment is made, to contribute information regarding the patient as part of the scheduling process. For example, the referring physician may provide data regarding the urgency of the appointment, and this data may be used for the prioritization engine for the purposes of accommodating the patient within the referral-target physician's schedule. In another example, the referring physician may indicate that the patient lives a great distance from the referral-target physician's facility. This distance may be used by the prioritization engine as a basis for scheduling the patient in the afternoon as opposed to the early morning, based at least in part on the perceived inconvenience of early morning travel from a great distance to make an early appointment.

In embodiments, physicians or other entities, such as hospitals, insurers and the like, may contribute data to the SSS as part of the scheduling protocol (e.g., in the form of a business rule that is associated with the prioritization engine) indicating a preference to schedule patients that are “in-network,” meaning that a patient that is within the network, such as a reimbursement, insurance, or practice group network, will be given a scheduling preference by the SSS.

In an example embodiment, using a client device associated with the SSS service and prioritization engine, a patient may schedule an appointment with a primary care physician. The primary care physician may indicate criteria within the physician learning module including, but not limited to, days and times s/he is available to schedule appointments, the types of insurance s/he is willing to accept, or some other type of scheduling preference data. The primary care physician may also indicate priorities for certain criteria including, but not limited to, types of referral sources. Continuing with the example, the patient may not have insurance, but rather may have a history of paying his/her medical costs out of pocket. The patient may also be a new client scheduling an appointment for the first time with the primary care physician. Based on the patient's information and the primary care physician's criteria, the patient may receive a medium priority rank when scheduling an appointment within the SSS service. The medium priority rank may be based in part on the averaging of the unfavorable datum “unknown patient,” an favorable datum “pays out of pocket.” The SSS service may continue to store and maintain the patient's data based on ongoing event results and accordingly adjust the patient's priority ranking for future reference. For example, if the patient pays his/her bill on time and arrived to the scheduled appointment on time, this data may cause the prioritization engine to more favorably rank the patient for subsequent scheduling requests.

In embodiments, a user interface may be associated with the SSS. For example, a physician may be prompted by a user interface to login and provide a password, or if new to the SSS, may be directed to a first time user web page. A physician directed to a first time user web page may provide his/her name and whether s/he is a primary care provider or a specialist. A physician may then choose a user login name and password. Based on the physician's status as either a primary care provider or specialist, the physician may be directed to a primary care provider profile web page or a specialist profile web page. Both profile web pages may ask a physician for the following, but not limited to, his/her name, location, specialty, medical school, residency, board certification, awards and years in practice. Both profile web pages may allow a physician to indicate criteria and preferences for scheduling appointments including, but not limited to, the types of insurance s/he is willing to accept and/or the priority in which s/he will accept types of insurance, the referral sources s/he is willing to accept and/or the priority of acceptance, or the type of availability a physician has. A primary care physician may also indicate whether s/he would like to schedule and/or receive referrals.

Continuing the example, a physician may be a repeat user of the user interface. After entering his/her login name and password, a physician may choose a type of action s/he wants to accomplish including, but not limited to, referring a patient, updating his/her availability, updating his/her priority indications, or changing his/her schedule. The user interface may allow a physician to make a referral. The physician may indicate criteria and preferences for making a referral including, but not limited to, a specialty or specialties, a distance from the present location, an ideal time and/or next available appointment, a reason for the referral, limiting results to the physician's favored specialists or viewing all available specialists. The user interface may utilize the data provided by the physician to create a search results web page. The search results web page may display specialists with appointments meeting the physician's previously indicated criteria and preferences. The user interface may list the following options including, but not limited to, the specialist's closest time match to the physician's desired time and/or the next available time, or an alternate specialist if a physician's previously indicated criteria and preferences do not yield any available specialists within a given time period of the desired time (e.g., 24 or 48 hours).

Continuing the example, the user interface may enable specialists to prioritize criteria including, but not limited to physicians, type of insurance, the diagnoses the specialist treats or appointment times. The specialist may then designate his/her availability (e.g., always available, generally available, or rarely available) based on the previously indicated criteria. For example, a specialist may choose the type or types of insurance s/he accepts and designate his/her availability based on they type of insurance (e.g., Blue Cross Blue Shield, always available). The user interface may enable a primary care physician to find a specialist by specialty or by name. The user interface may also enable a primary care physician to view a list of specialists s/he has referred to previously and designate a specialist or specialists with favored status. The user interface may enable a primary care physician to indicate whether s/he would like to receive referrals from other physicians.

Continuing the example, the user interface may enable physicians to create schedule templates. A physician may indicate criteria and preferences including, but not limited to, how much time the template should fill (e.g., entire day, half a day, an hour), the type and duration of appointments (e.g., new patients, returning patients, physical exams, etc.), what time the template should start and end, and how the time in the template should be divided initially. Based on the physician's inputted data, the user interface may enable a physician to choose a time or times to designate the type and duration of appointments the physician desires to make available. The user interface may then generate a reusable template the physician may use with new dates and/or add prioritization criteria to. The user interface may enable physicians to manage their schedules by viewing or changing appointments and creating new appointments. A physician may select a date and time to edit any appointment. A physician may also create new appointments for a day and time based on previously created schedule templates or manually input the information. A physician may also have the option of prioritizing newly created appointments.

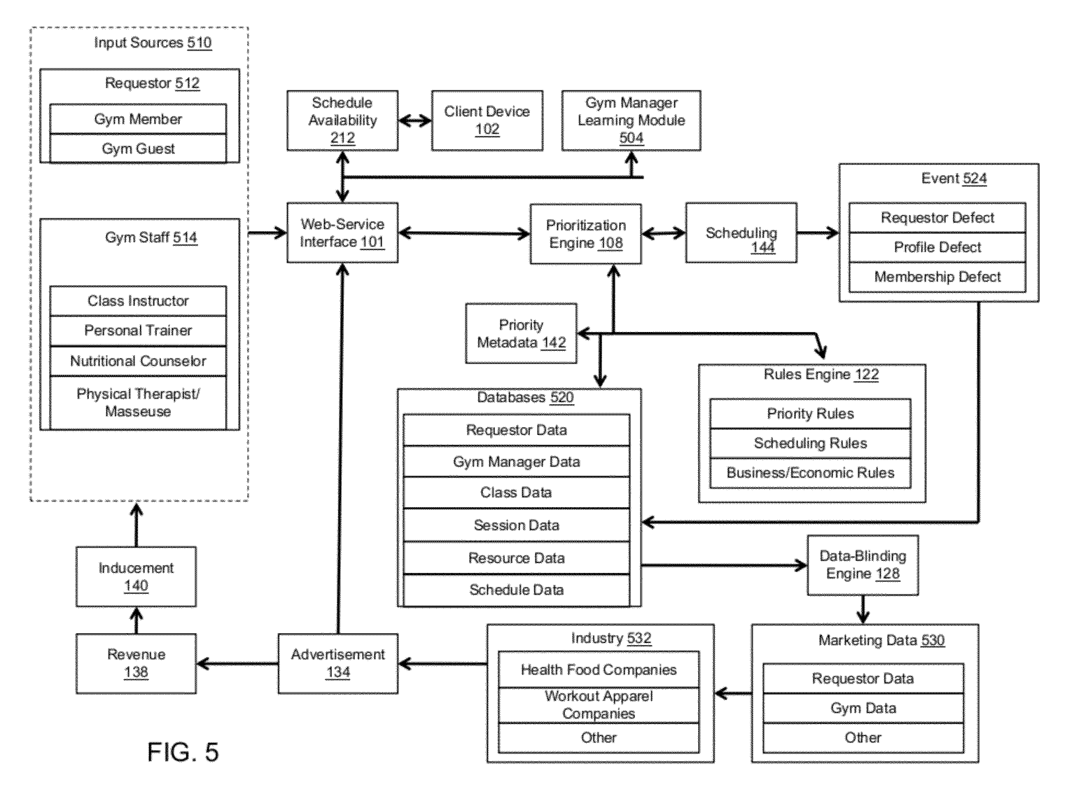

As shown in FIG. 5, in embodiments of the present invention, a Smart Scheduling System 100 is provided that is enabled to gather, store, manage, aggregate, search and process scheduling data to produce prioritized event scheduling for appointments, reservations, procedures or other interactions based at least in part on the manual or algorithmic application of scheduling rules. In embodiments, the SSS 100 may be a web service and/or hard-wired service with which a plurality of client devices 102 may be associated. Client devices 102 may include, but are not limited to, a mainframe computer, server, desktop computer, laptop computer, e-notebook, e-book, e-tablet, PDA, cellular phone, or some other digital device. The scheduling service 100 may have a user interface that is enabled to receive data inputs from human users and/or from automated or machine data sources. The client devices 102 may be physically linked to the web service, such as within a gym's office intranet, or may link to the web service remotely over a wireless or other type of remote connection, including but not limited to the Internet or cellular telecommunications system. The client device 102 may enable a user, such as a gym member, guest, gym manager or some other user type, to log in to an account to input data to schedule an event (e.g., an appointment with a personal trainer, or some other event type) including, but not limited to, a preferred day and time, whether the gym member is new or recurrent, and for what purpose the member is scheduling the appointment. The SSS 100 service may be further associated with a gym manager learning module 504. The gym manager learning module 504 may enable gym managers or other gym professionals to input criteria and preferences for scheduling appointments including, but not limited to, specific days and/or times a personal trainer is available to schedule appointments, the types of classes that are available, or whether a racquetball court is open for use on a particular day at a particular time, and the like. The gym manager learning module 504 may also enable gym managers to prioritize types of data. These prioritized data may be utilized by the SSS 100 as priority metadata 142 that informs the prioritization engine 108 how to handle a given scheduling request that is received by the SSS 100 service. In an example, a gym manger, may select the number of times a member is allowed to miss a class for which the member scheduled an appointment, select the number of guests that are able to use the gym at any one time, prioritize class or equipment access by revenue generated by members, or provide some other type of data to the SSS 100 service. In another example, a gym manager may create a list of classes, specify the class size of each class, and specify suggested replacement classes for those gym members who do not qualify for a selected class, or provide some other type of data to the SSS 100 service.

Still referring to FIG. 5, the SSS 100 may facilitate the retrieval of data input sources 510, such as from a requestor 512, including, but not limited to, data from or relating to gym members or gym guests. Gym member metadata may include, but is not limited to, profile metadata, membership metadata, or prioritization metadata. Profile metadata may include, but is not limited to, name, contact information, date of birth, health questionnaire responses, payment method, photo, notes, attendance history, healthcare provider, or referrals. Profile metadata may be entered directly into a database by the gym manager or other gym personnel (collectively, “gym staff” 514) at the gym using a personal computer, tablet computer, mobile device, or the like. In other embodiments profile metadata may be entered directly into a database by the gym member either at the gym or from another location by accessing a web browser or application that connects to the SSS 100 via the Internet using a personal computer, tablet computer, mobile computer, or the like. In other embodiments, the metadata may be fully or partially populated by connecting to the profile of a gym user on a social network, including, but is not limited to, Facebook or LinkedIn. Membership metadata may include, but is not limited to, facility access, resource access, price, recurrence or term, or rewards or benefits or credits. Prioritization metadata may include, but is not limited to, revenue generated by the gym member, attendance, or other prioritization data. Revenue generated metadata may include, but is not limited to, membership dues, services payments, or referrals. Attendance metadata may include, but is not limited to, overall facility, classes, session, or resources. Other prioritization metadata may include, but is not limited to, VIP status, protected status, or reported violations of the gym code of conduct. Gym guest metadata may include, but is not limited to, profile metadata or prioritization metadata. Profile metadata may include, but is not limited to, name, contact information, date of birth, health questionnaire responses, payment method, photo, notes, attendance history, healthcare provider, or referrals. Other prioritization metadata may include, but is not limited to, time, day, number of guest passes issued, number of guest passes used, or reported violations of the gym code of conduct.

The SSS 100 may include a prioritization engine 108 that may utilize the data from the input sources 510 to make informed scheduling decisions for scheduling an event 524 that is requested to be scheduled buy a user of the scheduling service 100. The prioritization engine 108 may process and review data including, but not limited to, revenue generated metadata, attendance metadata, or other metadata as previously described above, in addition to priority metadata 142, data from a rules engine 122, or some other type of data 520. The rules engine 122 may include, but is not limited to, priority rules, scheduling rules or business/economic rules set by, for example, a gym manager. Priority rules may include, but are not limited to, rules governing preferences, such as a preference to schedule a slot in a yoga for gym members first then for gym guests if space is available after all gym member requests are met. Scheduling rules may include, but are not limited to, scheduling personal training sessions with a particular personal trainer only on a given day of the week, and the like. Business/economic rules may relate to providing a higher priority to gym members who generate a higher level of revenue for the gym, for example by purchasing a premium membership. Based at least in part on this data, the prioritization engine 108 may then schedule an event 524, such as an appointment meeting a gym member's criteria that is scheduled in accordance with the priorities set by the gym manager or other gym personnel. The occurrence of an event may yield additional data that may be used by the SSS 100. For example, a gym member may not show up for a session with a personal trainer, may not show up on time, a personal trainer may have an unpleasant experience with a referral source, and so forth. Such event data may be stored in databases that are associated with the SSS 100 service, as described herein, and further used by the prioritization engine 108 when scheduling subsequent events 524. This data may be further used to alter or add to the rules engines 122 that may be used by the prioritization engine 108. For example, if following five scheduled spin classes, each event results in the gym member missing a class, the SSS may update the rules engine to include a rule that alters the priority given to the gym member's requests to schedule a spin class.

Still referring to FIG. 5, in embodiments, the SSS may include a data-blinding engine 128. The data-blinding engine 128 may transform stored data that is associated with the web-service into anonymous information that may be used as marketing data, 530 such as that relating to gym members, gym managers, gym facilities, and the like. The marketing data 530 may be sold to industry 532 including, but not limited to, health food companies, workout apparel companies, businesses targeting gym employees, or some other type of entity or institution, and used to generate revenue 138. For example, the marketing data 530 may have value to industry 532 for the purposes of targeting advertising 134 to specific gym member populations (e.g., women ages 25-35), gym managers (e.g., gym managers in New York City), or some other entity or institution (e.g., a gym with a growing young adult population base). The revenue 138 generated from the advertising 134 may be used, in part, to induce 140 individuals and entities to use the SSS 100.

In embodiments, a gym member may request an appointment for a class, session, or resource. A class may be, but is not limited to, yoga, spin, Pilates, dance, or martial arts classes. Metadata associated with the class, session, or resource appointment may be, but is not limited to, time, date, instructor, location, level, type, class size, price, or class length. A session may be, but is not limited to, personal training, nutrition counseling, or physical therapy/massage. Metadata associated with the session may be, but is not limited to time, purpose/goal, price, package, session length, date, trainer, trainer type, trainer experience level, counselor, counselor type, counselor experience level, therapist, therapist experience level, treatment type, and the like. A resource may be, but is not limited to, exercise equipment, courts, pool, or childcare. Exercise equipment may include, but is not limited to, bikes, treadmills, elliptical trainers, and the like. Exercise equipment metadata may include, but is not limited to, type/model, time, date, location, or workout duration. Courts may include, but are not limited to, basketball, racquetball, or squash. Courts metadata may include, but is not limited to, time, date, location, duration, player level, other players' levels, or workout type. Pool metadata may include, but is not limited to, time, date, location, pool, lane, lane type, or workout location. Child care metadata may include, but is not limited to, time, date, location, session duration, age, gender special needs, cost, or package.

In embodiments, the SSS may present a schedule or a decision to a requestor 512 or a scheduler. A requestor may be, but is not limited to, a gym member or gym guest. A scheduler may be, but is not limited to, a gym manager or other gym employee. Metadata associated with a schedule presentation to may include, but is not limited to, calendar metadata or event metadata. Calendar metadata may include, but is not limited to, the overall gym facility or gym requestors. Event metadata may include approval metadata, denial metadata, or deferred metadata. Approved metadata may include, but is not limited to, a confirmation number, event details, or a marketing message. Denial metadata may include, but is not limited to, a reason, event details, a suggested replacement event, or a marketing message. Deferred metadata may include, but is not limited to, a reason, event details, a suggested replacement, a remediation action, or a marketing message. Metadata associated with a decision presentation may include but is not limited to approval metadata, denial metadata, or deferred metadata, as described herein.

In an example embodiment, using a client device that is associated with the SSS service and prioritization engine, a gym member may request to schedule an appointment at a spin class. The gym manager may have previously indicated scheduling preference criteria based at least in part on data entered using the gym manager learning module 504. This data may include, but is not limited to, days and times the spin class is available to schedule appointments, the types of skill level the spin class is willing to accept, or some other type of scheduling preference data. The gym manager may also indicate priorities for certain criteria including, but not limited to, requestor types. Continuing with the example, the requestor may be a gym member or a gym guest. If the requestor is a gym member s/he may have a history of showing up late to a scheduled appointment or of not showing up at all without giving notice. The gym member may have a history of not paying his/her membership fee on time, making it difficult to process his/her membership. Based on this gym member's information history and the gym manger's indicated criteria, the SSS service and prioritization engine may generate appointment options for the gym member to choose from that conform to the scheduling preferences previously entered by the gym manager. Due to this gym member's unfavorable history with the gym manager, s/he may be bumped or rescheduled if a more favorable gym member makes an appointment. In another embodiment, the prioritization engine may force the scheduling of a favorable, or highly ranked gym member by bumping a currently scheduled gym guest. For example, the SSS may bump a non-paying gym guest from a given timeslot in a spin class to accommodate the paying gym member.

In embodiments, the Smart Scheduling System may enable the collection of fitness class fees, dues, or other payments from gym members at the time of a visit or in connection with their appointment. Determining the payment or fee amount may be facilitated by accessing data or metadata associated with the gym member that is scheduling the appointment, such as membership status, membership level, or some other type of data that is associated with the gym member. As part of collecting and processing the payment or fee, the Smart Scheduling System may charge a commission, such as a percentage of the payment or fee, to the gym, or some other entity associated with the payment or fee. In another example, the Smart Scheduling system may require that a fee be paid, such as a holding fee, by the gym member or other person that is attempting to schedule an appointment in a given timeslot. The holding fee may be scaled according to a criterion, including but not limited to, priority metadata, priority rules, scheduling rules and the like. For example, a holding fee to reserve a calendar timeslot that a gym has indicated is a high value or high priority timeslot may be larger than the holding fee required to reserve a lower priority timeslot in the gym's calendar. The holding fee may function as a type of deposit to hold the appointment time slot.

In an example embodiment, using the gym manager learning module associated with the SSS service and prioritization engine, a gym manager may refer a member to a suggested replacement event if the event requested by a gym member, for example, is not available. The gym manager may indicate criteria including, but not limited to alternative times, days or instructors. The gym manager's criteria may be processed with data provided by instructors using the SSS service, and may provide data including, but not limited to, days and times s/he is available to schedule appointments, the types of requestors s/he is willing to accept, or some other type of scheduling data or preference. An instructor may also indicate priorities for certain criteria including, but not limited to, skill levels of a requestor (e.g. beginner, intermediate, expert) s/he has for each requestor, selecting the types of requestors s/he allows for prioritizing appointments. Continuing with the example, the requestor with a beginner skill level may desire an appointment in a class for beginners, may be referred to an instructor who teaches a class for beginners with whom the requestor has been referred to by another requestor, and request a Wednesday afternoon appointment for a class for beginners, a favorable day and time for the instructor to teach classes for beginners. Based on gym manager's and instructor's inputted data, the SSS service and prioritization engine may generate an ideal class option for the gym manager to choose from and to make available to the requestor with a beginner skill level.

In another example embodiment, the SSS may enable the use of business rules or other data that allow multiple parties with whom events may be scheduled (e.g., personal trainers at a specific gym) to coordinate their schedules and interact within the prioritization engine processes. For example, a gym member may attempt to schedule an appointment with a first personal trainer that is unavailable, but rather that the SSS rejecting the gym member's scheduling request, the prioritization engine may utilize a business rule or some other data that is associated with the prioritization engine and determine that, while the first personal trainer in the group is unavailable, a second personal trainer, such as a colleague of the first personal trainer with similar credentials and permissions, is available, and based at least in part on this the SSS may present the gym member an opportunity to schedule an appointment with the second personal trainer instead. In another example embodiment, the SSS may enable the use of business rules or other data that allow multiple parties with whom events may be scheduled where the parties have differing credentials (e.g., a personal trainer and nutritional counselor) to coordinate their schedules and interact within the prioritization engine processes. For example, a gym member may attempt to schedule an appointment with a nutritional counselor that is unavailable, but rather that the SSS rejecting the gym member's scheduling request, the prioritization engine may utilize a business rule or some other data that is associated with the prioritization engine and determine that, while the nutritional counselor is unavailable, the gym member's personal trainer, is available, and based at least in part on this the SSS may present the gym member an opportunity to schedule an appointment with the personal trainer instead.

In embodiments, the SSS may enable class instructors, including a plurality of class instructors with a relationship with a requestor 512 for whom an attempt to schedule an appointment is made, to contribute information regarding the requestor as part of the scheduling process. For example, a yoga instructor may provide data regarding the requestor's skill level, and this data may be used for the prioritization engine for the purposes of accommodating the requestor with a list of the yoga instructor's classes at the appropriate skill level. In another example, the yoga instructor may indicate that the requestor has not attended the majority of classes s/he has scheduled. This attendance may be used by the prioritization engine as a basis for scheduling the requestor in a class that typically does not have high demand, based at least in part on the perceived potential absence from the class of the requestor.

In embodiments, gym managers or other gym staff, such as personal trainers, nutritional counselors and the like, may contribute data to the SSS as part of the scheduling protocol (e.g., in the form of a business rule that is associated with the prioritization engine) indicating a preference to schedule requestors that are gym members who have pre-purchased a package of sessions, meaning that a requestor that has already paid for a session, will be given a scheduling preference by the SSS.

In an example embodiment, using a client device associated with the SSS service and prioritization engine, a gym member may schedule an appointment for a spin class. The gym manager may indicate criteria within the gym manager learning module including, but not limited to, days and times is the spin class is available to schedule appointments, the skill level of requestors the instructor is willing to accept, or some other type of scheduling preference data. The gym manager may also indicate priorities for certain criteria including, but not limited to, type of requestor or type of membership package purchased. Continuing with the example, the requestor may be a gym member, rather than a gym guest, but may have a history of not attending classes that s/he has requested. The requestor may also be scheduling an appointment for the first time for the spin class. Based on the gym guest's information and the spin classes criteria, the gym guest may receive a medium priority rank when scheduling an appointment within the SSS service. The medium priority rank may be based in part on the averaging of the unfavorable datum “not attending requested classes,” and a favorable datum “gym member.” The SSS service may continue to store and maintain the gym member's data based on ongoing event results and accordingly adjust the gym member's priority ranking for future reference. For example, if the gym member begins to arrive to the classes s/he requested, this data may cause the prioritization engine to more favorably rank the gym member for subsequent scheduling requests.

In embodiments, a user interface may be associated with the SSS. For example, a personal trainer may be prompted by a user interface to login and provide a password, or if new to the SSS, may be directed to a first time user web page. A personal trainer directed to a first time user web page may provide his/her name and whether s/he is a personal trainer or spin class instructor, for example. A personal trainer may then choose a user login name and password. Based on the personal trainer's status as either a personal trainer or spin class instructor, the trainer may be directed to a personal trainer profile web page, rather than a spin class instructor profile web page. The personal trainer profile web page may ask a personal trainer for the following, but not limited to, his/her name, trainer type, trainer experience level, and price. The personal trainer profile web pages may allow a personal trainer to indicate criteria and preferences for scheduling appointments including, but not limited to, the dates and times s/he is available, the length of session he/she is available, the purpose/goal of a requestor, the price range a requestor is willing to pay, and if a requestor has already paid for a pre-paid package.

Continuing the example, a personal trainer may be a repeat user of the user interface. After entering his/her login name and password, a personal trainer may choose a type of action s/he wants to accomplish including, but not limited to, updating his/her availability, updating his/her priority indications, or changing his/her schedule. The user interface may enable personal trainers to prioritize criteria including, but not limited to dates and times s/he is available, the length of session he/she is available, the purpose/goal of the requestor, the price range the requestor is willing to pay, and if the requestor has already paid for a pre-paid package. The personal trainer may then designate his/her availability (e.g., always available, generally available, or rarely available) based on the previously indicated criteria. For example, a personal trainer may choose to accept a gym member who pays for each session individually or who has pre-purchased a package of sessions and designate his/her availability based on they type of payment (e.g., pre-purchased, always available).

Continuing the example, the user interface may enable personal trainers to create schedule templates. A personal trainer may indicate criteria and preferences including, but not limited to, how much time the template should fill (e.g., entire day, half a day, an hour), the type and duration of appointments (e.g., initial consultations, returning clients, etc.), what time the template should start and end, and how the time in the template should be divided initially. Based on the personal trainer's inputted data, the user interface may enable a personal trainer to choose a time or times to designate the type and duration of appointments the personal trainer desires to make available. The user interface may then generate a reusable template the personal trainer may use with new dates and/or add prioritization criteria to. The user interface may enable personal trainer to manage their schedules by viewing or changing appointments and creating new appointments. A personal trainer may select a date and time to edit any appointment. A personal trainer may also create new appointments for a day and time based on previously created schedule templates or manually input the information. A personal trainer may also have the option of prioritizing newly created appointments.

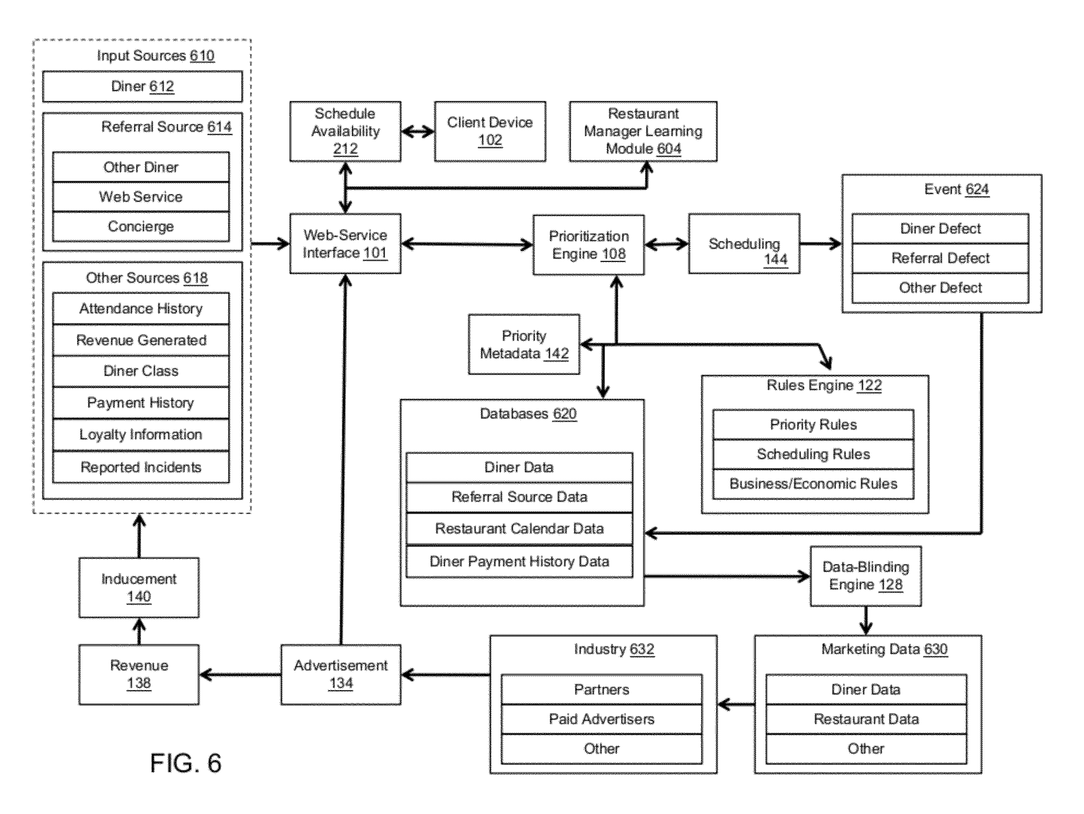

As shown in FIG. 6, in embodiments of the present invention, a Smart Scheduling System is provided that is enabled to gather, store, manage, aggregate, search and process scheduling data to produce prioritized event scheduling for appointments, reservations, procedures or other interactions based at least in part on the manual or algorithmic application of scheduling rules. In embodiments, the SSS may be a web service and/or hard-wired service with which a plurality of client devices may be associated. Client devices 102 may include, but are not limited to, a mainframe computer, server, desktop computer, laptop computer, e-notebook, e-book, e-tablet, PDA, cellular phone, or some other digital device. The scheduling service may have a user interface that is enabled to receive data inputs from human users and/or from automated or machine data input sources 610, such as a diner 612, or some other type of input or referral source 614. The client devices may be physically linked to the web service and web service interface 101, such as within a restaurant's office intranet, or may link to the web service remotely over a wireless or other type of remote connection, including but not limited to the Internet or cellular telecommunications system. The client device may enable a user, such as a diner or restaurant manager or some other user type, to log in to an account to input data to schedule an event (e.g., an dining reservation for a table for two, or some other event type) including, but not limited to, a preferred day and time, whether the diner is new or recurrent, and whether the diner is categorized a specific class of diner. The SSS service may be further associated with a restaurant manager learning module 604. The restaurant manager learning module 604 may enable restaurant managers or other restaurant professionals to input criteria and preferences for scheduling dining reservations including, but not limited to, specific days and/or times a restaurant is available to schedule dining reservations, the types of reservations that are available, or whether a certain class of diner 612 is granted priority access to tables in favorable locations within preferred timeslots, and the like. The restaurant manager learning module 604 may also enable restaurant managers to prioritize types of data. Other sources 618 of data may also be associated with the SSS and the web service interface 101 including, but not limited to, attendance history, revenue generated, diner class, payment history, loyalty information, reported incidents, or some other type of data or data source. These prioritized data may be utilized by the SSS as priority metadata 142 that informs the prioritization engine 108 how to handle a given scheduling request that is received by the SSS service. In an example, a restaurant manger, may select the number of tables available for VIP diners, select the number of tables that are available to diners referred by discounted deal sites, prioritize prime timeslot availability by revenue generated by diners, or provide some other type of data to the SSS service. In another example, a gym manager may create a special event, invite specific diners to the event, and determine a seating chart for the event based on common diner attributes, or provide some other type of data to the SSS service.

Still referring to FIG. 6, the SSS may facilitate the retrieval of data input sources including, but not limited to, data from or relating to diners. Diner metadata may include, but is not limited to, name, contact information, date of birth, photo, notes, attendance history, referrer, revenue generated, class, loyalty information, payment history, or reported incidents. Diner metadata may be entered directly into a database by the restaurant manager or other restaurant personnel at the restaurant using a personal computer, tablet computer, mobile device, or the like. In other embodiments diner metadata may be entered directly into a database by the diner either at the restaurant or from another location by accessing a web browser or application that connects to the SSS via the Internet using a personal computer, tablet computer, mobile computer, or the like. In other embodiments, the diner metadata may be fully or partially populated by connecting to the profile of a diner on a social network, including, but is not limited to, Facebook or LinkedIn. Referrer metadata may include but is not limited to other diners, web services, or concierges. Web services may include deal web services or direct web services. Deal web services may include, but are not limited to Groupon, Living Social, or other local deal services, and the like. Direct web services may include, but are not limited to Opentable, Yelp, or the like. Concierges may include but are not limited to credit card concierge services and hotel or other hospitality concierges. Revenue generated may include, but is not limited to direct spend or referrals. Class may include, but is not limited to, VIP status or restaurant critic. The SSS may include a prioritization engine that may utilize the data from the input sources to make informed scheduling decisions for scheduling an event this is requested to be scheduled by a user of the scheduling service. The prioritization engine may process and review data including, but not limited to, diner metadata, data from a rules engine 122, or some other type of data 620. The rules engine 122 may include, but is not limited to, priority rules, scheduling rules or business/economic rules set by, for example, a restaurant manager. Priority rules may include, but are not limited to, rules governing preferences, such as a preference to schedule a table by the window at a prime dinner timeslot for VIP diners first then for other diners if space is available after all VIP diner requests are met. Scheduling rules may include, but are not limited to, scheduling a seat at a table for a special event, and the like. Business/economic rules may relate to providing a higher priority to diners who generate a high level of revenue for the restaurant, for example by referring other diners to the restaurant. Based at least in part on this data, the prioritization engine may then schedule an event, such as a dining reservation meeting a diner's criteria that is scheduled in accordance with the priorities set by the restaurant manager or other restaurant personnel. The occurrence of an event 624 may yield additional data that may be used by the SSS. For example, a diner may not show up for a reservation, may not show up on time, and so forth. Such event data may be stored in databases 620 that are associated with the SSS service, as described herein, and further used by the prioritization engine 108 when scheduling subsequent events. This data may be further used to alter or add to the rules engines that may be used by the prioritization engine. For example, if following two scheduled dining reservations, each event results in the diner missing a reservation, the SSS may update the rules engine 122 to include a rule that alters the priority given to diner's requests to schedule a dining reservation.

Still referring to FIG. 6, in embodiments, the SSS may include a data-blinding engine 128. The data-blinding engine may transform stored data that is associated with the web-service into anonymous information that may be used as marketing data 630, such as that relating to diners, restaurant managers, restaurant partners, and the like. The marketing data 630 may be sold to industry 632 including, but not limited to, liquor companies, fashion companies, businesses targeting restaurant employees, or some other type of entity or institution, and used to generate revenue. For example, the marketing data 630 may have value to industry 632 for the purposes of targeting advertising to specific diner populations (e.g., married couples ages 25-35), restaurant managers (e.g., restaurant managers in Los Angeles), or some other entity or institution (e.g., a restaurant with a growing population base with high levels of disposable income). The revenue generated from the advertising may be used, in part, to induce individuals and entities to use the SSS.

In embodiments, a diner 612 may request an appointment for a table or a seat. Metadata associated with a table or seat may be, but is not limited to, time, date, location, or special event. Metadata associated with time may be, but is not limited to, more favorable times and less favorable times. More favorable times may be, but are not limited to breakfast times between 7:30 AM-9:30 AM, lunch times between the hours of 11:30 AM-1:30 PM, or dinner times between the hours of 6 PM-9 PM. Less favorable times may be, but are not limited to breakfast times before 7:30 AM, lunch times before the hours of 11:30 AM, or dinner times before 6 PM. Metadata associated with location may be, but is not limited to, more favorable locations and less favorable locations. More favorable locations may be, but are not limited to seat by the window, seats in a more private section of the restaurant, or the like. Less favorable seats may be, but are not limited to, seats near the bathroom or seats near the entrance of the kitchen, or the like. A special event may be, but is not limited to, a theme dinner or chef's table.

In embodiments, the Smart Scheduling System may enable the collection of reservation payments, or other payments from diners at the time of a restaurant visit or in connection with placing a restaurant reservation. Determining the payment amount may be facilitated by accessing data or metadata associated with the table to be reserved, information relating to the diner attempting to make the reservation, data relating to the time of the reservation, or some other type of data or metadata. As part of collecting and processing the payment or fee, the Smart Scheduling System may charge a commission, such as a percentage of the payment or fee, to the restaurant and/or the diner, or some other entity associated with the payment or fee. In another example, the Smart Scheduling system may require that a fee be paid, such as a holding fee, by the diner that is attempting to place the reservation. The holding fee may be scaled according to a criterion, including but not limited to, priority metadata, priority rules, scheduling rules and the like. For example, a holding fee to reserve a table in a calendar timeslot that a restaurant has indicated is a high value or high priority timeslot may be larger than the holding fee required to reserve a lower priority timeslot in the restaurant's calendar. The holding fee may function as a type of deposit to hold the reservation timeslot.

In embodiments, the SSS may present a schedule or a decision to a requestor or a scheduler. A requestor may be, but is not limited to, diner 612. A scheduler may be, but is not limited to, a restaurant manager or other restaurant employee. Metadata associated with a schedule presentation to may include, but is not limited to, calendar metadata or event metadata. Calendar metadata may include, but is not limited to, the overall restaurant facility or diners. Event metadata may include approval metadata, denial metadata, or deferred metadata. Approved metadata may include, but is not limited to, a confirmation number, event details, or a marketing message. Denial metadata may include, but is not limited to, a reason, event details, a suggested replacement event, or a marketing message. Deferred metadata may include, but is not limited to, a reason, event details, a suggested replacement, a remediation action, or a marketing message. Metadata associated with a decision presentation may include but is not limited to approval metadata, denial metadata, or deferred metadata, which is described above in detail.

In an example embodiment, using a client device 102 that is associated with the SSS service and prioritization engine 108, a diner 612 may request to schedule an appointment for a table. The restaurant manager may have previously indicated scheduling preference criteria based at least in part on data entered using the restaurant manager learning module 604. This data may include, but is not limited to, days and times tables are available to schedule appointments, the class of diner the restaurant is willing to accept, or some other type of scheduling preference data. The manager may also indicate priorities for certain criteria including, but not limited to, referrer, revenue generated, or class. Continuing with the example, the diner may have a history of showing up late to a scheduled appointment or of not showing up at all without giving notice. Based on this diner's information history and the restaurant manger's indicated criteria, the SSS service and prioritization engine 108 may generate appointment options for the diner to choose from that conform to the scheduling preferences previously entered by the restaurant manager. Due to this diner's unfavorable history with the restaurant, s/he may be bumped or rescheduled if a more favorable diner makes an appointment. In another embodiment, the prioritization engine may force the scheduling of a favorable, or highly ranked diner by bumping a currently scheduled diner. For example, the SSS may bump a non-VIP diner from a given table by a window to accommodate the VIP diner. Alternatively, the diner may be presented with scheduling opportunities that are not the preferred times that may be available because of the diner's poor attendance reputation.

In an example embodiment, using the restaurant manager learning module 604 associated with the SSS service and prioritization engine, a restaurant manager may refer a diner 612 to a suggested replacement event if the event requested by a diner, for example, is not available. The restaurant manager may indicate criteria including, but not limited to alternative times or days.

In embodiments, restaurant managers or other restaurant staff, may contribute data to the SSS as part of the scheduling protocol (e.g., in the form of a business rule that is associated with the prioritization engine) indicating a preference to schedule diners that are known to run-up high check amounts and tip well, meaning that a diner that with a high average check amount and tips well, will be given a scheduling preference by the SSS.

In embodiments, a user interface may be associated with the SSS. For example, a restaurant manager may be prompted by a user interface to login and provide a password, or if new to the SSS, may be directed to a first time user web page. A restaurant manager directed to a first time user web page may provide his/her name, for example. A restaurant manager may then choose a user login name and password. The restaurant manager may be directed to a restaurant manager profile web page. The restaurant manger web page may ask a restaurant manager for the following, but not limited to, his/her name, restaurant location, and the like. The restaurant manager's profile web pages may allow a restaurant manager's to indicate criteria and preferences for scheduling appointments including, but not limited to, the dates and times tables are available to different classes of diners, the attendance history of diners, revenue generated by diners, loyalty information of the diners, payment history of the diners, and the like.

Continuing the example, the user interface may enable restaurant managers to create schedule templates. A restaurant manager may indicate criteria and preferences including, but not limited to, how much time the template should fill (e.g., entire day, half a day, an hour), the type and duration of dining reservations, what time the template should start and end, and how the time in the template should be divided initially. Based on the restaurant manager's inputted data, the user interface may enable a restaurant manager to choose a time or times to designate the type and duration of appointments the restaurant manager desires to make available. The user interface may then generate a reusable template the restaurant manager may use with new dates and/or add prioritization criteria to. The user interface may enable the restaurant manager to manage their schedules by viewing or changing appointments and creating new appointments. A restaurant manager may select a date and time to edit any appointment. A restaurant manager may also create new appointments for a day and time based on previously created schedule templates or manually input the information. A restaurant manager may also have the option of prioritizing newly created appointments.

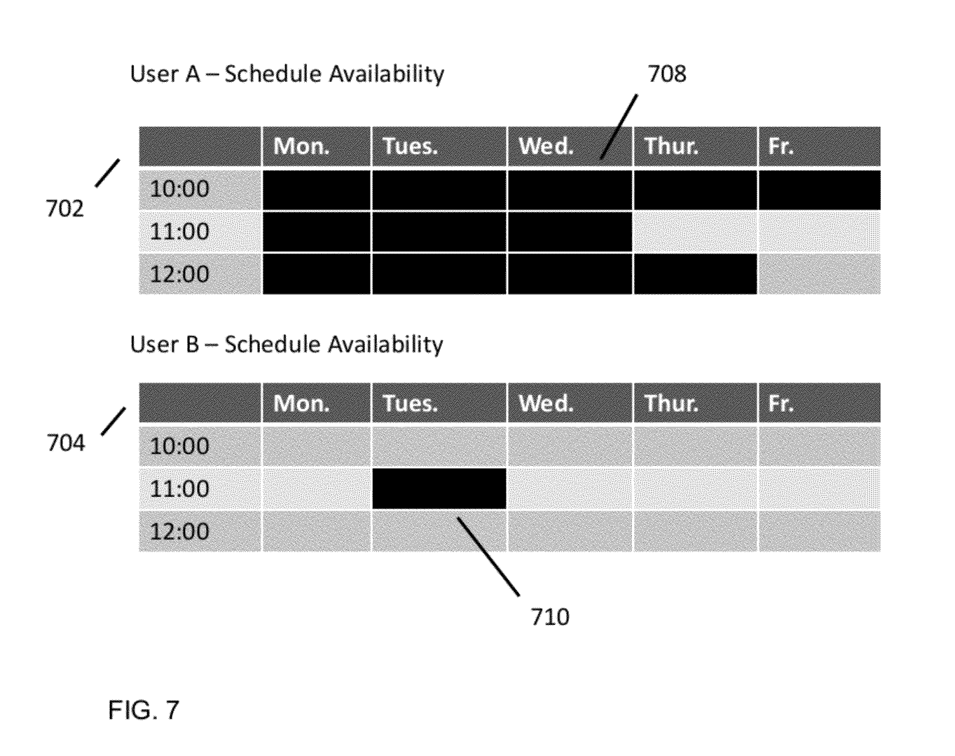

FIG. 7 illustrates how a schedule and availability in the schedule may be presented to two different people wanting to schedule an appointment with the same entity or person based on the principles of the present invention. In this example, the metadata associated with User A indicates that User A is not to be provided with all available schedule slots, but rather should only be presented with limited slots within the schedule 702 even though there is more time available in the schedule. User A is presented with many “blocked” times 708 and only a couple available times: Thur. at 11:00 and Fri. at 11:00 and 12:00. Based on the same schedule, schedule criteria and restriction information, User B is presented with fewer blocks times 710 that is User A, and has many more options in presentation 704 because the metadata associated with User B indicates that he should have access to preferred times.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed:

1. A method for prioritizing event scheduling, the method comprising a computer having a non-transitory computer readable medium having stored thereon instructions which, when executed by a processor of the computer, causes the processor to perform the steps of:
receiving a datum from an entity with whom an event may be scheduled, wherein the datum provides a scheduling preference of the entity;
storing the datum as a scheduling prioritization metadata within a prioritization database;
receiving a request to schedule an event with the entity from a user;
analyzing data within the prioritization database, and at least one user characteristic datum relating to the user, to form a user ranking;
using the user ranking to select a set of scheduling opportunities;
presenting the set of scheduling opportunities to the user; and
scheduling an event for the user with the entity in a schedule timeslot based at least in part on a selection made by the user from the set of scheduling opportunities, wherein the user is placed within the timeslot even if the timeslot were previously occupied by a second user so long as the user's ranking is higher than the second user's ranking.

2. The method of claim 1, wherein the entity is an institution.

3. The method of claim 2, wherein the institution is a hospital.

4. The method of claim 2, wherein the institution is a physician's office.

5. The method of claim 2, wherein the institution is a restaurant.

6. The method of claim 2, wherein the institution is a retail business.

7. The method of claim 1, wherein the entity is an individual.

8. The method of claim 7, wherein the individual is a physician.

9. The method of claim 1, wherein the datum relates to a physician group.

10. The method of claim 1, wherein the datum relates to a referral source.

11. The method of claim 1, wherein the datum relates to a reimbursement source.

12. The method of claim 1, wherein the datum relates to a patient.

13. The method of claim 1, wherein the at least one user characteristic relates to a prior interaction with the entity.

14. The method of claim 1, wherein the preferential placement within the timeslot results in double-booking the timeslot so that the second user and the user both are scheduled within the timeslot.

15. A system for creating event scheduling priority metadata, the system comprising:
a computer having a processor;
a memory which is operably assessable to the processor;
software which is operable on the processor, the software including a physician learning model program and an event scheduling program, wherein the software is adapted to:
use the physician learning model to receive a scheduling preference datum from a physician that expresses a scheduling preference of the physician;
cause the storage in the memory of the scheduling preference datum as a priority metadatum that is associated with the event scheduling program;
receive an event datum relating to an event result that is associated with a patient's prior scheduled event;
analyze the event datum in conjunction with the scheduling preference datum to produce an analysis result; and
create a priority rule associated with the patient based at least in part on the analysis result, wherein the priority rule quantitatively models the priority to be given to the patient and is adapted to be used by the event scheduling program to place the patient within the physician's calendar when the patient attempts to schedule a second event at a time subsequent to the event result.

16. The system of claim 15, wherein the event datum is based at least in part on the occurrence of a defect during the event.

17. The system of claim 16, wherein the defect is a missed appointment.

18. The system of claim 16, wherein the defect is related to a payment.

19. A method for prioritizing event scheduling, the method comprising a computer having a non-transitory computer readable medium having stored thereon instructions which, when executed by a processor of the computer, causes the processor to perform the steps of:
a. Receiving an inquiry for an appointment on a schedule from a user;
b. Developing a profile of the user based on metadata characterizing the user;
c. Reviewing stability criteria associated with a plurality of times in the schedule;
d. Comparing the profile with the stability criteria to select a stability appropriate time from the plurality of times; and presenting the stability appropriate time to the user as a schedule opportunity.

20. A method for prioritizing event scheduling, the method comprising a computer having a non-transitory computer readable medium having stored thereon instructions which, when executed by a processor of the computer, causes the processor to perform the steps of:
a. Receiving an inquiry for an appointment on a schedule from a user;
b. Developing a profile of the user based on metadata characterizing the user;
c. Reviewing priority criteria associated with a plurality of times in the schedule;
d. Comparing the profile with the stability criteria to select a priority appropriate time from the plurality of times; and presenting the priority appropriate time to the user as a schedule opportunity.
